(19) United States
(12) Patent Application Publication
(10) Pub. No.: US 2018/0020626 A1
(43) Pub. Date: Jan. 25, 2018

(54) Modular Greenhouse and Kit

(71) Applicant: Amelia's Backyard Farm Company, LLC, McKinney, TX (US)

(72) Inventors: Kody Kellogg, Los Angeles, CA (US); Steven Scott Pershern, Dallas, TX (US)

(73) Assignee: Amelia's Backyard Farm Company, LLC, McKinney, TX (US)

(21) Appl. No.: 15/275,353

(22) Filed: Sep. 24, 2016

Related U.S. Application Data
(60) Provisional application No. 62/222,801, filed on Sep. 24, 2015.

(51) Int. Cl. A01G 9/16; A01G 9/14; A01G 9/24

(52) U.S. Cl. CPC A01G 9/16; A01G 9/246; A01G 9/247; A01G 9/1438; E04H 5/08

(57) ABSTRACT

An apparatus is provided. There is a frame that is secured in a fixed position with ribs positioned between first and second ends of the frame. First and second walls that are respectively positioned at the first and second ends, which have support members that are secured together and arranged to form a lattice with portals and panels secured within the portals. There is a fan secured in at least one of the portals, and an entryway located within with first wall. A covering member is secured to the frame, and an evaporative cooler located in proximity the second wall.

### CROSS-REFERENCE TO RELATED APPLICATIONS

This application claims priority to U.S. Provisional Patent Application Ser. No. 62/222,801, entitled “Modular Greenhouse and Kit,” filed on Sep. 24, 2016, which is hereby incorporated by reference for all purposes.

### TECHNICAL FIELD

The invention relates generally to a greenhouse and, more particularly, to modular greenhouse and kit.

### BACKGROUND

Modular greenhouses are commercially available, and there are a wide variety that are available from retailers. Additionally, modular greenhouses for commercial applications have been available for many years. Some examples of such systems are: U.S. Pat. No. 4,188,764; U.S. Pat. No. 4,928,425; U.S. Pre-Grant Publ. No. 2007/0028512; U.S. Pre-Grant Publ. No. 2015/0196002; U.S. Pat. No. 5,101,593; U.S. Pat. No. 3,807,088; U.S. Pre-Grant Publ. No. 2014/0259908; U.S. Pre-Grant Publ. No. 2008/0000151; and U.S. Pat. No. 6,622,425. These greenhouses, however, do not suit the needs of many applications and industries particularly well—such as hydroponics. Therefore, there is a need for an improved greenhouse and kit.

### SUMMARY

An embodiment of the present invention, accordingly, provides an apparatus. The apparatus comprises a frame that is secured in a fixed position, wherein the frame has a plurality of ribs positioned between first and second ends of the frame, and wherein the plurality of ribs collectively form an interior space; first and second walls that are respectively positioned at the first and second ends, wherein each of the first and second walls includes: a plurality of support members that are secured together and arranged to form a lattice with a plurality of portals; and a plurality of panels secured within the portals of the lattice; at least one fan secured in at least one of the portals; an entryway located within with first wall that permits access to the interior space; and a covering member, formed of a plurality of sections, that is secured to the frame; an evaporative cooler located in proximity the second wall, wherein the evaporative cooler includes: a plurality of watering channels to allow gravity flow of water; and a plurality of air channels to allow air to flow to and from the interior space.

In accordance with an embodiment of the present invention, the panels are substantially transparent to sunlight.

In accordance with an embodiment of the present invention, the evaporative cooler is located within the second wall.

In accordance with an embodiment of the present invention, the plurality of support members further comprises: a plurality of vertical support members, wherein each vertical support member is substantially perpendicular to the base, and wherein the vertical support members are substantially parallel to one another; and a plurality of horizontal support members, wherein each horizontal support member is substantially parallel to the base and one another.

In accordance with an embodiment of the present invention, the evaporative cooler further comprise a plurality of corrugated sheets, wherein corrugations of adjacent sheets are oriented at right angles to one another.

In accordance with an embodiment of the present invention, the covering member is formed of ethylene tetrafluoroethylene (ETFE).

In accordance with an embodiment of the present invention, the frame further comprises a base that is substantially rectangular in shape and having: a first style located at the first end; a second style located at the second end; and a plurality of rails that are each secured to the first and second styles and that extend between the first and second styles.

In accordance with an embodiment of the present invention, the apparatus further comprises a foundation that is substantially rectangular having a first and second side members, and wherein the covering member has first and second ends that are secured to first and second tensioning members, respectively, and wherein the frame further comprises a breakdown assembly having: a plurality of interior strips positioned within the interior space along the first and second side members of the foundation; first and second sets of exterior strips that are generally L-shaped, wherein the first and second sets are positioned along the each of first and second side members opposite the interior strips, wherein the first and second sets of exterior strips form first and second U-channels along the first and second side members, wherein the at least three of the ribs are secured to the first and second sets of exterior strips within the first and second U-channels; and first and second tensioning spaces located within the first and second U-channels, respectively, that are positioned to receive the first and second tensioning members as the covering member extends over a portion of at least first set of exterior strips.

In accordance with an embodiment of the present invention, an apparatus is provided. The apparatus comprises: a general rectangular foundation that is adapted to be positioned partially below a support surface, wherein the foundation includes first and second side members that are generally parallel to on another when assembled, wherein, when assembled, each of the first and second side members has a first surface and an opposite second surface; an assembly having: a first strip that is adapted to be secured to the first surface of the first support member; a second strip that is adapted to be secured to the first surface of the second support member; a third strip that is adapted to be secured to the second surface of the first support; a fourth strip that is adapted to be secured to the second surface of the first support, wherein the third and fourth strips are dimensioned to form a first U-channel with a first tensioning space, when assembled; a fifth strip that is adapted to be secured to the second surface of the second support; and a sixth strip that is adapted to be secured to the second surface of the second support, wherein the third and fourth strips are dimensioned to form a second U-channel with a second tensioning space that are substantially parallel to the first U-channel, when assembled; a plurality of ribs that are adapted to be secured in the first and second U-channels and extend over the foundation so as to form an interior space; a covering member having a plurality of sections, wherein each section of the covering member has first and second ends; first and second tensioning members are secured to the first and second ends of each section of the covering member, wherein the covering member is dimensioned to extend over the plurality of ribs, the fourth strip, and the sixth strip such that the first and second tensioning members are positioned within the first and second tensioning spaces, respectively, so that the covering member is tensioned when assembled; first and second walls that are adapted to be respectively positioned to be perpendicular to the first and second side members, wherein each of the first and second walls includes: a plurality of support members that are secured together and arranged to form a lattice with a plurality of portals; and a plurality of panels secured within the portals of the lattice, wherein at least some of the panels are substantially transparent to sunlight; an entryway located within with first wall that permits access to the interior space; and an evaporative cooler in proximity to the second wall.

In accordance with an embodiment of the present invention, the ribs further comprise: first and second end ribs that are adapted to be positioned in proximity to the first and second walls, respectively; a central rib that is adapted to be positioned between the first and second end ribs; a plurality of support ribs that are secured between the central rib and at least one of the first and second end ribs.

In accordance with an embodiment of the present invention, the central rib further comprises a plurality of central ribs that are each adapted to be positioned between the first and second end ribs, and wherein the plurality of support ribs includes support ribs that are adapted to be secured between the plurality of central ribs.

In accordance with an embodiment of the present invention, the plurality of support members further comprises: a plurality of vertical support members, wherein each vertical support member is substantially perpendicular to the base, and wherein the vertical support members are substantially parallel to one another; and a plurality of horizontal support members, wherein each horizontal support member is substantially parallel to the base and one another.

In accordance with an embodiment of the present invention, the evaporative cooler is located within the interior space of and further comprise a plurality of corrugated sheets, wherein corrugations of adjacent sheets are oriented at right angles to one another.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1 and 2 are front isometric views of an example of a greenhouse in accordance with an embodiment of the present invention;

FIG. 3 is an isometric view of the frame of the greenhouse of FIG. 1;

FIG. 4 is a side elevation view of the greenhouse of FIG. 1;

FIGS. 5A and 5B are a front and rear elevation views of the greenhouse of FIG. 1, respectively;

FIG. 6 is an exploded view of the greenhouse of FIG. 1;

FIG. 7 is a view of the disassembled frame and covering member of the greenhouse of FIG. 6;

FIG. 8 is an isometric view of the rear wall of the greenhouse of FIG. 1;

FIG. 9 is an isometric view of the front wall of the greenhouse of FIG. 1;

FIG. 10 is an isometric view of the shroud of the greenhouse of FIG. 1;

FIG. 11 is an isometric view of a portion of securing assembly of the frame of the greenhouse of FIG. 1;

FIG. 12 is a front elevation view of the portion of the frame shown in FIG. 11;

FIG. 13 is an alternative example of the frame for the greenhouse of FIG. 1; and

FIGS. 14-16 are alternative configurations for the example greenhouse shown in FIG. 1.

### DETAILED DESCRIPTION

Refer now to the drawings wherein depicted elements are, for the sake of clarity, not necessarily shown to scale and wherein like or similar elements are designated by the same reference numeral through the several views.

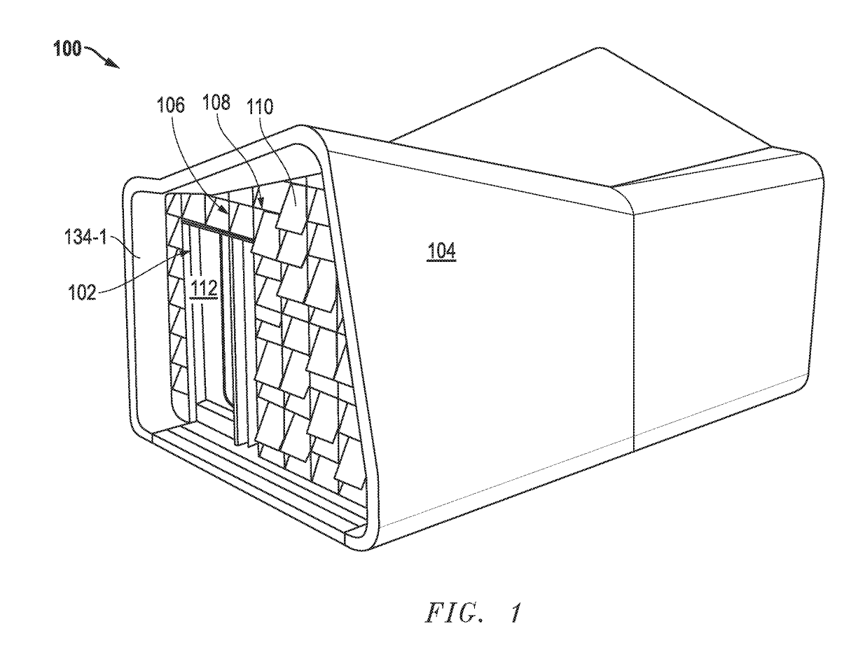

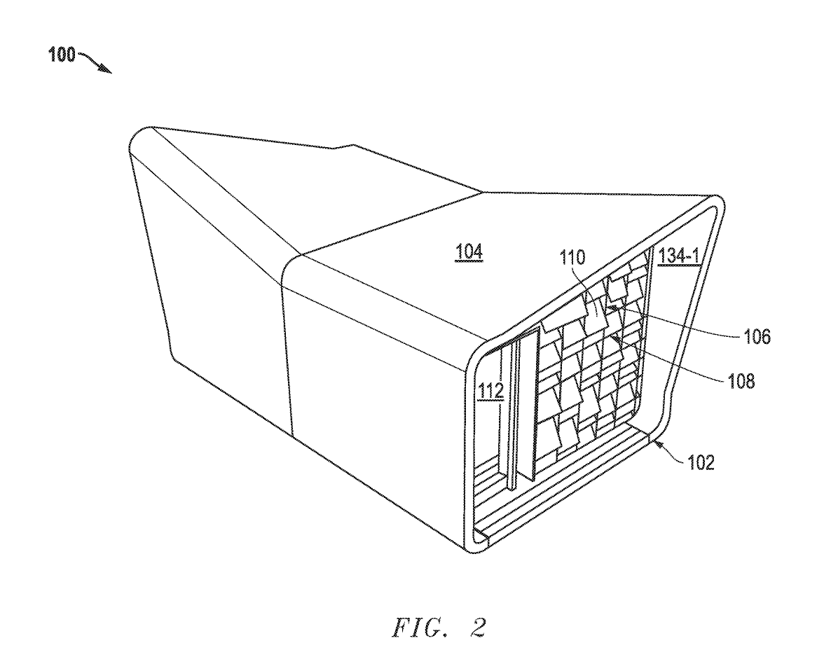

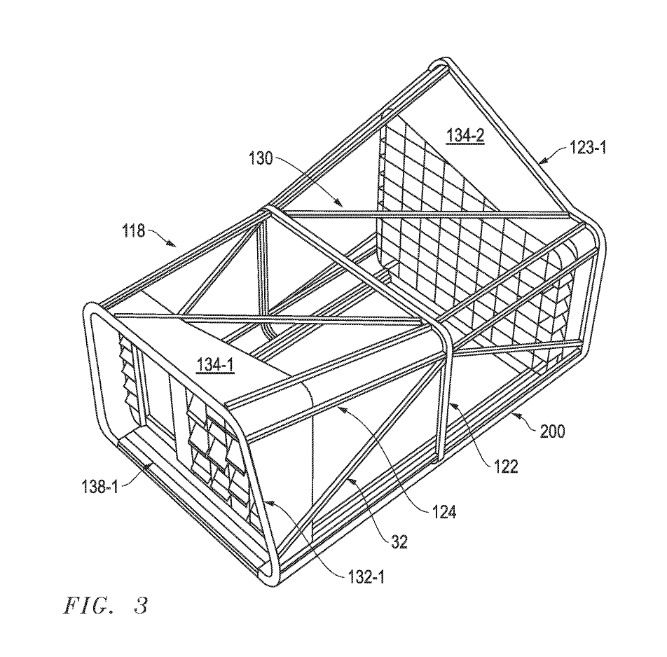

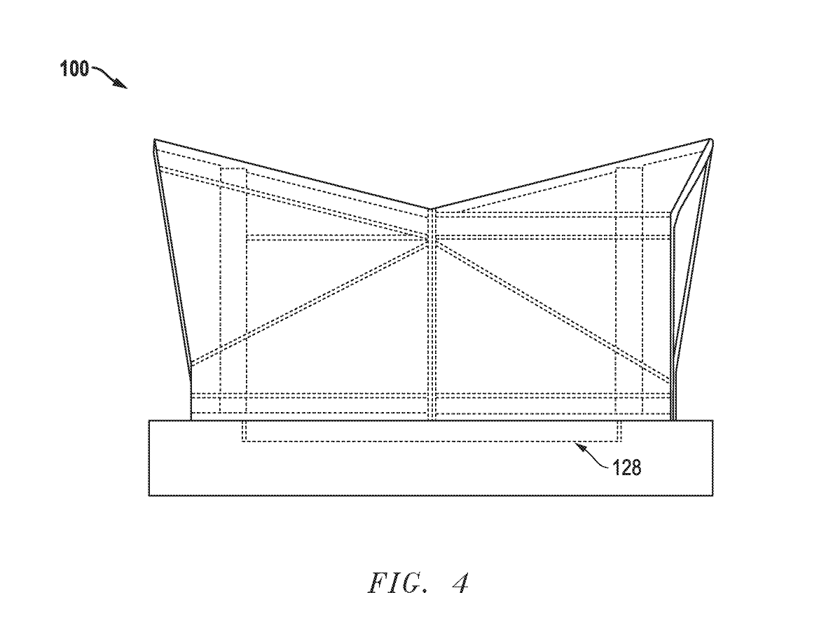

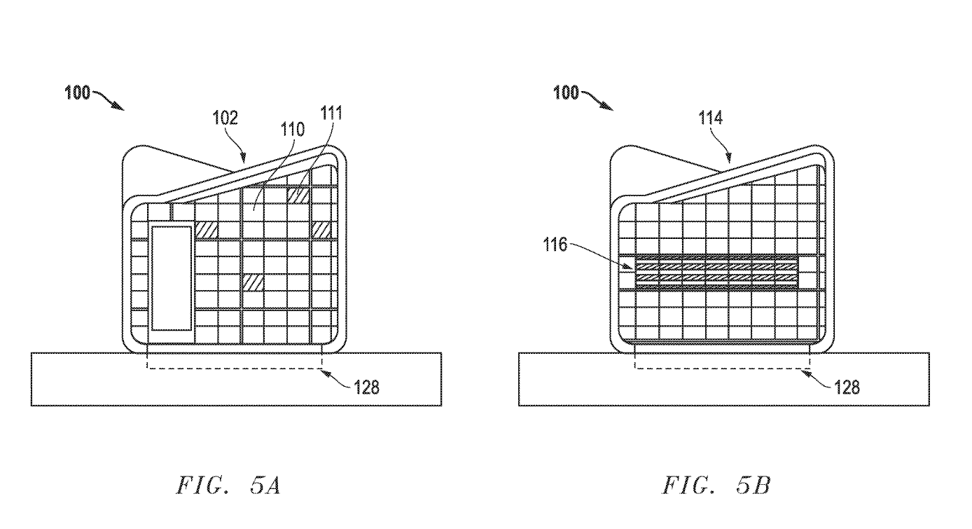

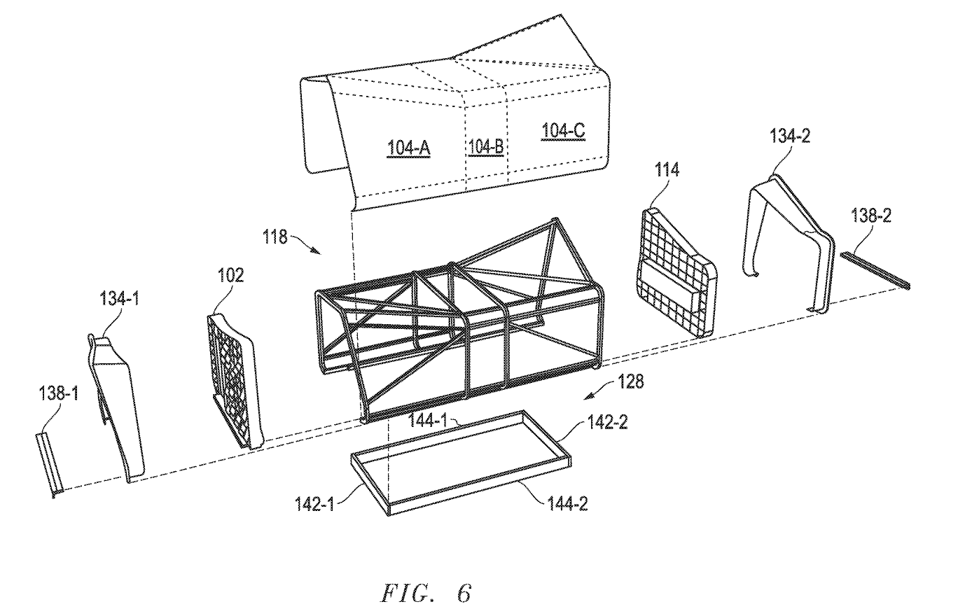

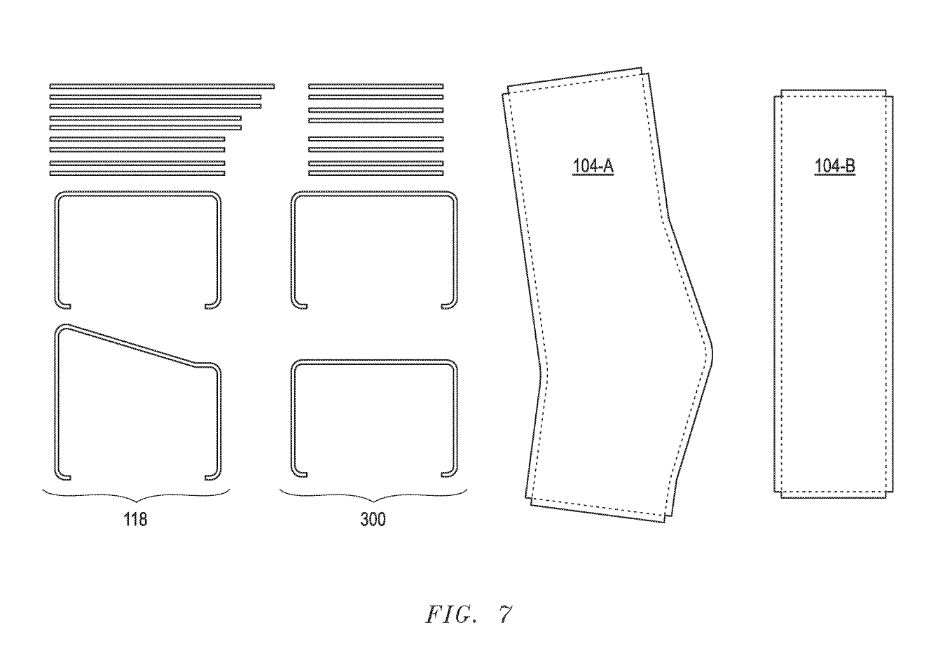

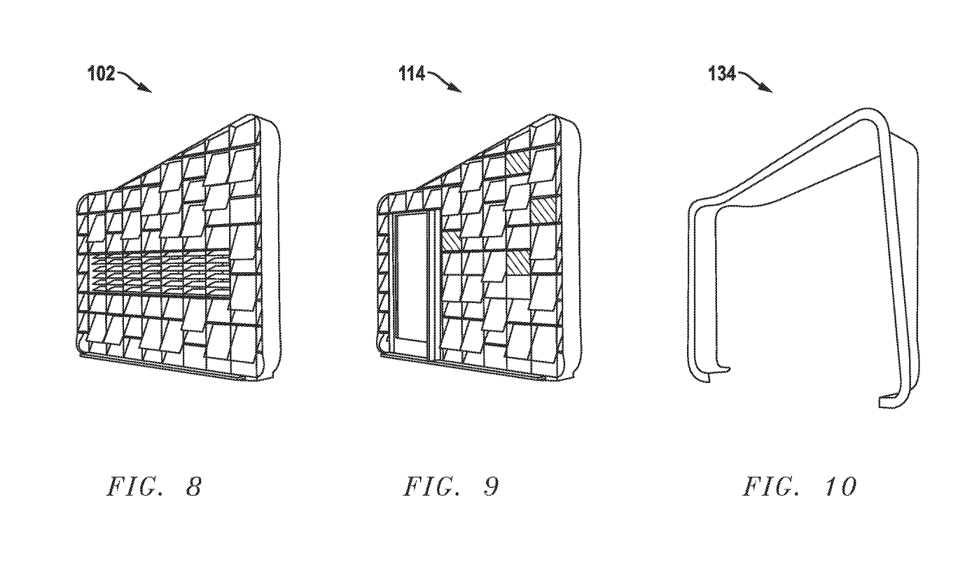

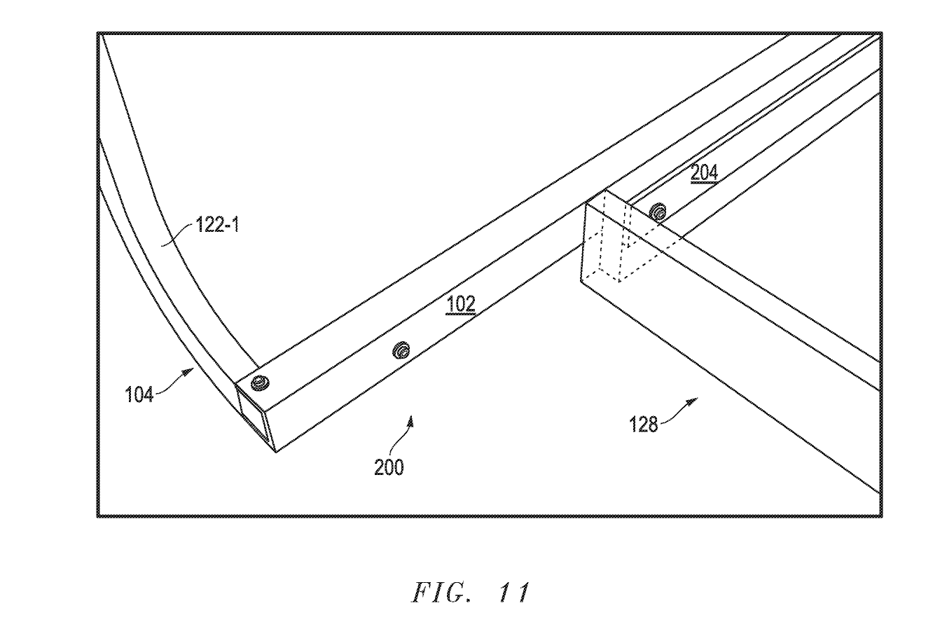

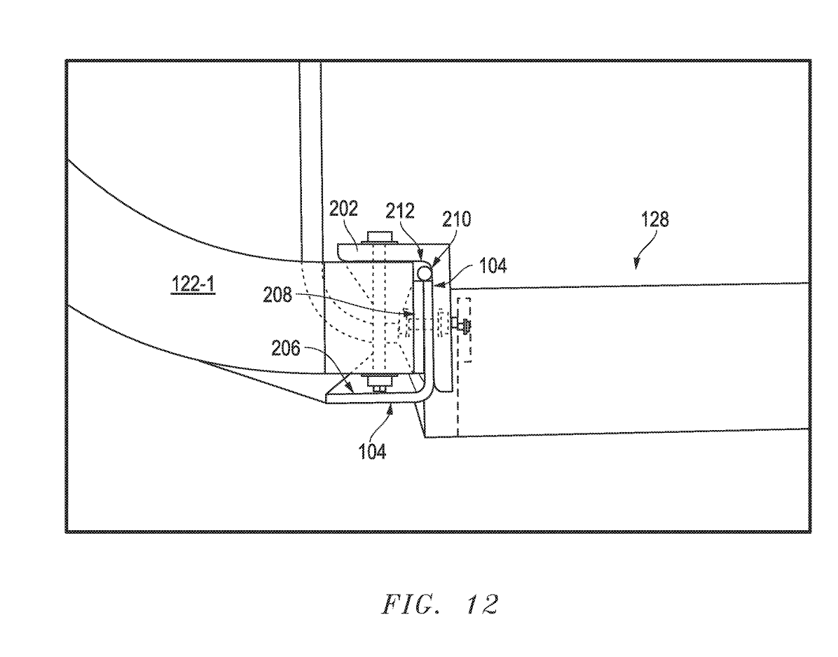

Turning to FIGS. 1 through 12 of the drawings, an example of a greenhouse 100 in accordance with a preferred embodiment of the present invention is shown. The greenhouse 100 is generally designed to be modular (e.g., to be assembled onsite from prefabricated components) for use in hydroponics gardening or agriculture. However, the greenhouse 100 is not limited to hydroponics. Typically, the greenhouse 100 is assembled over a foundation 128 or secured to a hard surface (e.g., concrete) to allow to allow for appropriate airflow and to generally ensure that the greenhouse 100 remains in its desired location.

In most instances, the foundation 128 is inset into the ground where gravel is leveled and compacted over a water resistant barrier. Typically, the foundation 128 (which can be seen in greater detail in FIGS. 4, 5, and 11) can be comprised of four supporting members (e.g., side members 144-1 and 144-2, and wall members 142-1, and 142-2). The members 142-1, 142-2, 144-1, and 144-2 are usually arranged in the form of a rectangle that partially extend below and above a ground surface (as shown in FIGS. 4, 5, and 11). Alternatively, the foundation 128 can be omitted, and the frame (e.g., 118-2) can be bolted to a hard surface (e.g., concrete). An example of such a configuration can be seen in FIG. 13, which is described below in greater detail.

Once the foundation 128 is set in place, the frame 118 can be positioned over and secured to the foundation 128. Typically, the frame 118 is assembled on site by the use of a kit (which is shown in part in FIG. 7). As shown and as secured to the foundation 128, there can be a breakdown assembly 200 (which is described in greater detail below). On either end (as shown in this example), there are end ribs 122-1 and 122-2. These end ribs 122-1 and 122-2 typically have the same configuration for ease of manufacture and can be bolted or otherwise removably secured to the assembly 200. Support ribs can then be secured (e.g., bolted) to the end ribs 122-1 and 122-2 and central ribs hat are adjacent to the end walls 102 and 114. As shown in the figures, only a single central rib is shown (which, for example, would be 10 feet by 16 feet in a generally rectangular shape), but the center section of the greenhouse 100 can be expanded in length by the use of extension sections (e.g., reference numeral 300 shown in FIG. 7). Over the frame 118, a covering member 104 can then be secured along the assembly (as described below) and on each end. Typically, shrouds 134-1 and 134-2 are inserted on either end so as to secure the covering member 104 to the end ribs 123-1 and 123-2. The covering member 104 may be mechanical secured to the shrouds 134-1 and 134-2 (e.g., by mechanical snaps) or may be held in place through an interference fit. The covering member 104 is typically formed of ethylene tetrafluoroethylene (ETFE). A second layer of the covering member 104 can be mechanically secured to the frame 118-1 (e.g., snapped or bolted) on the interior space of the greenhouse 100 so as to provide insulation. Alternatively, the covering member 104 can be formed of other materials so as to have desired insulating properties; for example, an insulating layer may be coextruded between two ETFE layers.

Additionally, the covering member 104 can be formed of several subsections. As shown, the covering member 104 can be comprised of end sections 104-A and center sections 104-B. The number of center sections 104-B can be increased when the length of the greenhouse is expanded (e.g., using extension section 300). For the example shown in FIG. 1, no center sections 104-B are used. As shown in FIG. 7, there are tabs along the periphery of the sections 104-A and 104-B. These tabs allow the sections (e.g., 104-A and 104-B) to be secured to one another (either permanently or with a mechanical breakdown joint) or frame 118.

Alternatively, as shown in the example of FIG. 13, the frame 118-2 can comprised of a base 420 and ribs 422-1 to 422-7 that can mechanically secured (e.g., bolted) to a hard surface (e.g., concrete). The number of ribs 422-1 to 422-7 can vary based on cost, application, and a number of other factors. Typically, the frame is formed of a metal (e.g., aluminum or steel), but it may also be comprised of a plastic (e.g. polycarbonate) or other composite materials. The base 420 can take on a variety of shapes, but it is typically desirable to have one that is rectangular in shape that overlays the foundation 128. As shown, the base 420 can have styles 424-1 and 424-2 located at each end of the base 420 with rails 426-1 and 426-2 extending therebetween. In this example, two rails 126 form the perimeter of the base 420 and are welded to the styles 424 and then bolted to the portion of the foundation 128 that extends above the ground surface. The ribs 422-1 to 422-7 can then be secured along the perimeter of the base 420 to form an interior space for the greenhouse 100. The entire frame 118-2 can be prefabricated with the ribs 422-1 to 422-7 permanently secured to the base 420 (e.g., brazed, glued, or welded) or with breakdown joints (e.g., ribs 422-1 to 422-7 bolted to the base 420). The styles 424 and rails 422 may also be secured to one another through breakdown joints (e.g., bolted together) or may be permanently secured in another manner (e.g., brazed or glued).

For the frame 118 shown, a breakdown assembly 200 can be used. This assembly 200 can entirely use breakdown joints (e.g., bolted) to more easily assemble the greenhouse 100 onsite. Typically, along the interior of members 144-1 and 144-2, an interior support strip 204 (which can have a generally rectangular cross-section) is used to secure the assembly 200 to the foundation 128. This strip 204 can be set either above or below the surface level, but it is desirable to have it extend to the top of the form to ensure that the covering member 204 remains taught. On the exterior of the members 144-1 and 144-2 are two exterior support strips 202 and 206 can be used. Typically, strips 202 and 206 are L-shaped (similar to angle iron) and are arranged to for a U-channel. Strip 206—because it is in contact with the covering member 104—is typically formed of a flexible material (e.g. rubber). Additionally, there may be other strips or spacers formed of flexible materials (e.g., rubber) between strip 202 and the covering member 104. The ends of the covering member 104 are permanently secured to a tensioning member 210 (e.g., a cylindrical rod). In the U-channel formed by strips 202 and 206 (as shown), there can be a tensioning space 212 in which the tensioning member 210 is placed. Usually, the covering member 104 extends around the strip 206 (which faces the foundation 128 and the support surface or ground) so that a portion of the covering member 104 faces the support surface or ground. A spacer 208 can then also be used in the U-channel. The strip 202, 204, and 206 and spacer 208 can then be bolted together at predetermined locations. Because of the positioning of the covering member 104, the bolts extend through the covering member 104, so to generally prevent tearing of the covering member 104, collars (not shown) are secured to the covering member 104 at these predetermined locations—which are similar to those used on conventional tarps. These collars can be formed of metal (e.g., steel) or other wear resistant materials. The ribs 123, 124, 130, 132, and/or 422 can then, themselves, be bolted to the strips 202 and 206 so as to form the frame 118-1 and 118-2.

With the frame 118 or 118-2 in place, the end walls 102 and 114 can be installed. Typically, the end walls 102 and 114 are comprised of an entry wall 102 and a rear wall 114—which are positioned adjacent to ribs 122-1 and 122-2 of frame 118. With frame 118, base members 138-1 and 138-2 can be also used to help secure walls 102 and 114 in place. Each of the walls 102 and 114 are formed of supporting members 106 and 108 that are secured together for form a lattice with portals. As shown in the examples of FIGS. 1-5, the support members generally comprise vertical support members 106 (which are typically arranged to be substantially perpendicular to the base 128 and parallel to one another) and horizontal support members 108 (which are generally parallel to one another and the support surface or ground). The support members 106 and 108 are typically formed of aluminum, polycarbonate, wood/plywood, or composite beams that are notched so as to be interlocked with one another. Within the portals of the lattice formed by the support members 106 and 108, panels 110 can be secured. The panels 110 are typically formed of polycarbonate and are substantially transparent to sunlight (e.g., conventional materials used for greenhouse paneling). These panels 110 also typically prevent airflow to and from the interior space of the greenhouse 100. But, the ports are dimensioned to receive conventional greenhouse fans 111 to force air into and out of the interior space of the greenhouse 100. As shown in the example depiction in FIGS. 1-5, the panels 110 are oriented at an angle of about 30 degrees from normal. Additionally, the entry wall 102 includes an entry way 112 (e.g., doored entry) to allow access to the interior space of the greenhouse 100.

The rear wall 114 also can serve another purpose in addition to allowing airflow. As shown, the rear wall 114 includes channels 116 that permit airflow. Evaporative coolers used in greenhouse applications are both commercially available and are well-known. Evaporative coolers can be placed within the channels 116 (i.e., integrated into the rear wall 114). Alternatively, the evaporative coolers may be housed within the interior space of the greenhouse 100 adjacent to the channels 116, meaning that there can be another interior wall that holds the evaporative cooler or that there can be a freestanding evaporative cooler within the interior space of the greenhouse. These evaporative coolers allow for the temperature of the interior space to be cooled (e.g., air conditioned) and are generally comprised of corrugated sheets (e.g., cardboard) where the corrugations of adjacent sheets are oriented at right angles to one another. Typically, the channels formed by the corrugations are at 45 degree angles to the support surface or ground. The sheets are also spaced far enough apart from one another to allow for water to be gravity fed across air flowing through the evaporative cooler. The air flow across the evaporative cooler can be created through a forced air system (e.g., fan 111).

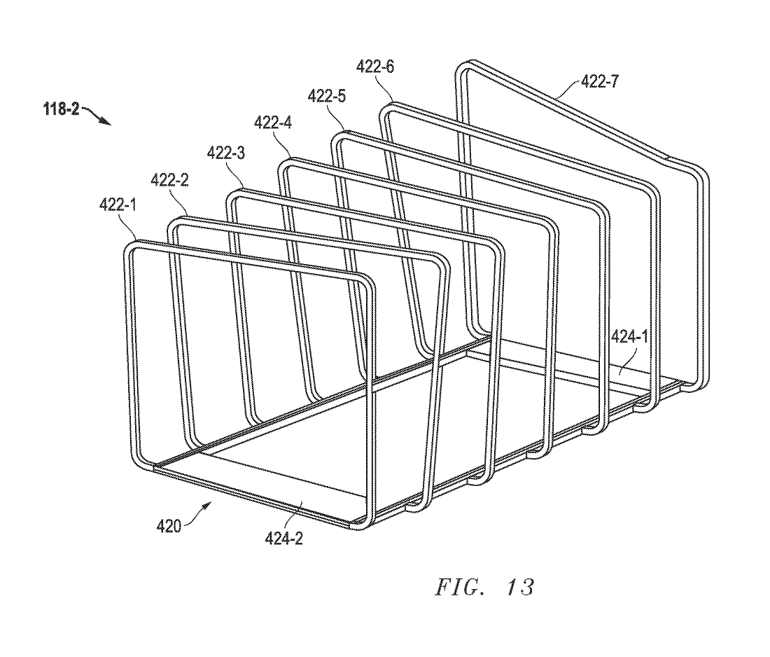

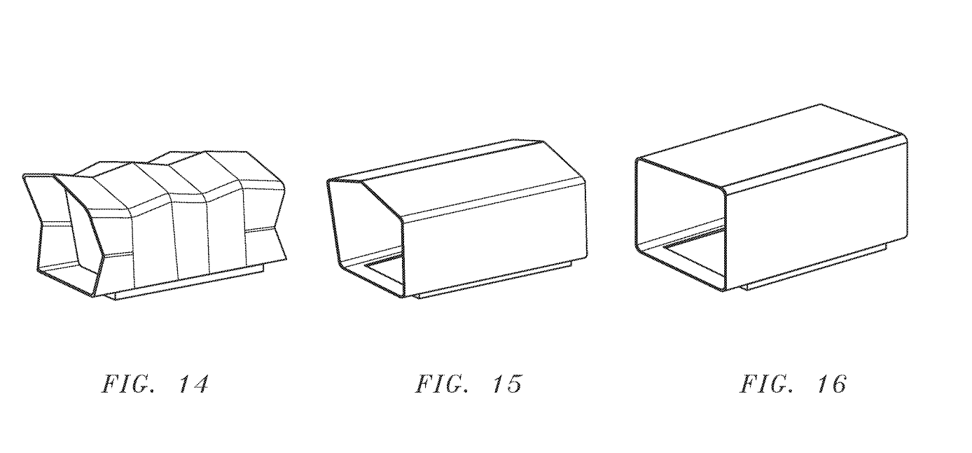

The shape of the greenhouse 100 can also vary. As shown in FIGS. 14-16, the shapes can be varied for aesthetic purposes or may be adjusted to fit the environment in which it is placed.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. An apparatus comprising:
a frame that is secured in a fixed position, wherein the frame has a plurality of ribs positioned between first and second ends of the frame, and wherein the plurality of ribs collectively form an interior space;
first and second walls that are respectively positioned at the first and second ends, wherein each of the first and second walls includes:
a plurality of support members that are secured together and arranged to form a lattice with a plurality of portals; and
a plurality of panels secured within the portals of the lattice;
at least one fan secured in at least one of the portals;
an entryway located within with first wall that permits access to the interior space; and
a covering member, formed of a plurality of sections, that is secured to the frame;
an evaporative cooler located in proximity the second wall, wherein the evaporative cooler includes:
a plurality of watering channels to allow gravity flow of water; and
a plurality of air channels to allow air to flow to and from the interior space.

2. The apparatus of claim 1, wherein the panels are substantially transparent to sunlight.

3. The apparatus of claim 2, wherein the evaporative cooler is located within the second wall.

4. The apparatus of claim 3, wherein the plurality of support members further comprises:
a plurality of vertical support members, wherein each vertical support member is substantially perpendicular to the base, and wherein the vertical support members are substantially parallel to one another; and
a plurality of horizontal support members, wherein each horizontal support member is substantially parallel to the base and one another.

5. The apparatus of claim 4, wherein evaporative cooler further comprise a plurality of corrugated sheets, wherein corrugations of adjacent sheets are oriented at right angles to one another.

6. The apparatus of claim 5, wherein the covering member is formed of ethylene tetrafluoroethylene (ETFE).

7. The apparatus of claim 6, wherein the frame further comprises a base that is substantially rectangular in shape and having:
a first style located at the first end;
a second style located at the second end; and
a plurality of rails that are each secured to the first and second styles and that extend between the first and second styles.

8. The apparatus of claim 7, wherein the apparatus further comprises a foundation that is substantially rectangular having a first and second side members, and wherein the covering member has first and second ends that are secured to first and second tensioning members, respectively, and wherein the frame further comprises a breakdown assembly having:
a plurality of interior strips positioned within the interior space along the first and second side members of the foundation;
first and second sets of exterior strips that are generally L-shaped, wherein the first and second sets are positioned along the each of first and second side members opposite the interior strips, wherein the first and second sets of exterior strips form first and second U-channels along the first and second side members, wherein the at least three of the ribs are secured to the first and second sets of exterior strips within the first and second U-channels; and
first and second tensioning spaces located within the first and second U-channels, respectively, that are positioned to receive the first and second tensioning members as the covering member extends over a portion of at least first set of exterior strips.

9. An apparatus comprising:
a general rectangular foundation that is adapted to be positioned partially below a support surface, wherein the foundation includes first and second side members that are generally parallel to on another when assembled, wherein, when assembled, each of the first and second side members has a first surface and an opposite second surface;
an assembly having:
a first strip that is adapted to be secured to the first surface of the first support member;
a second strip that is adapted to be secured to the first surface of the second support member;
a third strip that is adapted to be secured to the second surface of the first support;
a fourth strip that is adapted to be secured to the second surface of the first support, wherein the third and fourth strips are dimensioned to form a first U-channel with a first tensioning space, when assembled;
a fifth strip that is adapted to be secured to the second surface of the second support; and
a sixth strip that is adapted to be secured to the second surface of the second support, wherein the third and fourth strips are dimensioned to form a second U-channel with a second tensioning space that are substantially parallel to the first U-channel, when assembled;
a plurality of ribs that are adapted to be secured in the first and second U-channels and extend over the foundation so as to form an interior space;
a covering member having a plurality of sections, wherein each section of the covering member has first and second ends;
first and second tensioning members are secured to the first and second ends of each section of the covering member, wherein the covering member is dimensioned to extend over the plurality of ribs, the fourth strip, and the sixth strip such that the first and second tensioning members are positioned within the first and second tensioning spaces, respectively, so that the covering member is tensioned when assembled;
first and second walls that are adapted to be respectively positioned to be perpendicular to the first and second side members, wherein each of the first and second walls includes:
a plurality of support members that are secured together and arranged to form a lattice with a plurality of portals; and
a plurality of panels secured within the portals of the lattice, wherein at least some of the panels are substantially transparent to sunlight;
an entryway located within with first wall that permits access to the interior space; and
an evaporative cooler in proximity to the second wall.

10. The apparatus of claim 9, wherein the ribs further comprise:
first and second end ribs that are adapted to be positioned in proximity to the first and second walls, respectively;
a central rib that is adapted to be positioned between the first and second end ribs;
a plurality of support ribs that are secured between the central rib and at least one of the first and second end ribs.

11. The apparatus of claim 10, wherein the central rib further comprises a plurality of central ribs that are each adapted to be positioned between the first and second end ribs, and wherein the plurality of support ribs includes support ribs that are adapted to be secured between the plurality of central ribs.

12. The apparatus of claim 11, wherein the plurality of support members further comprises:
a plurality of vertical support members, wherein each vertical support member is substantially perpendicular to the base, and wherein the vertical support members are substantially parallel to one another; and
a plurality of horizontal support members, wherein each horizontal support member is substantially parallel to the base and one another.

13. The apparatus of claim 12, wherein evaporative cooler is located within the interior space of and further comprise a plurality of corrugated sheets, wherein corrugations of adjacent sheets are oriented at right angles to one another.

14. The apparatus of claim 13, wherein the covering member is formed of ETFE.
